(19) United States
(12) Patent Application Publication
(10) Pub. No.: US 2026/0141883 A1
(43) Pub. Date: May 21, 2026

(54) Universal Guitar Nut Pickup and Signal Processing System with Integrated AI, Sustainer, and Note Bender Capability

(71) Applicant: Dean Bowes, Mableton, GA (US)

(72) Inventor: Dean Bowes, Mableton, GA (US)

(21) Appl. No.: 19/444,717

(22) Filed: Jan. 9, 2026

(51) Int. Cl. G10H 3/18; G10D 3/04; G10H 1/00; G10H 1/053

(52) U.S. Cl. CPC G10H 3/186; G10D 3/04; G10H 1/0058; G10H 1/053; G10H 3/181; G10H 2210/221; G10H 2220/155

(57) ABSTRACT

The present invention relates to a universal guitar nut system that integrates multiple pickup technologies, AI-driven signal processing, sustain enhancement, and note-bending capabilities into a single modular assembly. The system captures string vibrations directly at the nut, enabling acoustic-like and electric tonal output independent of bridge pickups or body resonance. It supports piezoelectric, magnetic, optical, and future sensing technologies, providing flexible signal routing via wired or wireless outputs. AI modules analyze performance in real-time, dynamically shaping tone, sustain, and harmonic response. A piezo-actuated sustainer provides controlled string vibration for infinite sustain, while integrated note-bender functionality allows pitch modulation directly at the nut. The system is compatible with standard and Floyd Rose-equipped guitars, requiring no structural modifications, offering musicians enhanced tonal versatility, expressive control, and seamless integration with modern digital workflows.

### FIELD OF THE INVENTION

This invention relates to guitar hardware and musical instrument signal processing. More specifically, it concerns a universal guitar nut assembly that incorporates multiple pickup technologies, real-time AI-driven sound processing, sustain enhancement, and note-bending mechanisms. The system applies to both electric and acoustic guitars, including traditional nuts and Floyd Rose locking nut configurations.

### BACKGROUND OF THE INVENTION

Traditional guitar nuts serve primarily as passive contact points between strings and the headstock, influencing tone, sustain, and string stability. Existing innovations have focused on pickups at the bridge or saddle, Floyd Rose locking nuts with piezo pickups, or sustain systems that modify string behavior via external actuators. However, these approaches are limited:
1 Limited Pickup Placement—Most pickups are installed in the bridge or body, failing to capture string vibrations directly at the nut.
2 Restricted Signal Control—Existing systems do not provide real-time AI-based tone shaping or adaptive response to playing dynamics.
3 Sustain Limitations—Sustain mechanisms are typically bridge-based, limiting expressive capabilities.
4 Lack of Modularity and Compatibility—Previous systems often require instrument-specific modifications, preventing universal application across guitar types.

Accordingly, there is a need for a universal, modular guitar nut system that:
Captures string vibrations at the nut,
Integrates multiple pickup types,
Provides AI-driven signal processing,
Enables sustain enhancement,
Incorporates note-bending functionality,
Operates without permanent modification to the instrument, and
Supports both standard and Floyd Rose locking nut configurations.

### SUMMARY OF THE INVENTION

The present invention provides a universal guitar nut system that integrates multiple pickup technologies, AI-driven signal processing, sustain enhancement, and note-bending functionality into a single modular assembly. The system captures string vibrations directly at the nut, providing high-fidelity signal output for both acoustic-like and electric tones. It supports piezoelectric, magnetic, optical, and emerging pickup technologies, offering flexibility for current and future instrument designs.

An integrated AI module analyzes playing dynamics in real-time, dynamically modifying tone, harmonics, and sustain. A piezo-actuated sustainer provides controlled vibration to maintain notes indefinitely, while a note-bender mechanism enables pitch modulation directly at the nut.

Key features of the invention include:
Compatibility with standard guitar nuts and Floyd Rose locking nuts without structural modification.
Modular pickup assembly for piezo, magnetic, optical, or future sensing technologies.
AI-driven signal processing, providing real-time tone shaping, dynamic harmonics, and adaptive sustain.
Sustain enhancement, allowing fundamental, harmonic, or AI-adaptive sustain.
Note bending functionality, enabling expressive pitch modulation directly at the nut.
Wired and wireless output, for seamless integration with amplifiers, digital audio workstations, or effects processors.

The invention solves long-standing limitations in guitar hardware by:
1 Capturing string vibrations at the optimal location—the nut—for acoustic-quality signals.
2 Providing universal application, supporting both traditional and Floyd Rose-equipped guitars.
3 Expanding expressive control, including sustain and note bending without bridge modification.
4 Allowing future-proof adaptability for evolving pickup and signal processing technologies.

This system provides guitarists with enhanced tonal versatility, expressiveness, and digital integration, creating a platform for next-generation instrument performance.

### DETAILED DESCRIPTION OF THE INVENTION

### 1. Overview

The invention is a modular guitar nut assembly that transforms the traditionally passive guitar nut into an active signal capture and modulation interface. The system:
Captures string vibrations at the nut for high-quality signal output.
Supports multiple pickup types, including piezoelectric, magnetic, optical, and future sensing technologies.
Integrates AI-driven processing for real-time tone shaping, harmonic enhancement, and adaptive sustain.
Provides a piezo-actuated sustainer for extended notes and harmonic control.
Includes a note-bender mechanism for expressive pitch modulation.
Offers wired and wireless outputs for flexible connectivity.
Is retrofit-installable on existing guitars without structural modification, compatible with traditional nuts and Floyd Rose locking nuts.
In a practical embodiment, the modular assembly sits above or within the nut, housing pickup sensors, piezo actuators, PCB, battery, and wireless transmitter. Initial prototypes may be relatively large, but future iterations may reduce size and weight through optimized circuitry, materials, and energy-efficient components. This embodiment also incorporates principles from prior piezo pickup systems adapted for Floyd Rose locking nut configurations, enabling acoustic-quality string vibration capture on locking nuts.

### 2. Components

The universal nut assembly comprises the following core components:
Pickup Assembly: Modular sensors embedded within or beneath the nut, capable of detecting string vibrations across multiple technologies.
AI Processing Module: Onboard or connected processor analyzing performance in real-time, applying adaptive tone shaping, EQ, sustain control, and harmonic enhancement.
Sustain Mechanism: Piezoelectric actuators that vibrate strings to maintain notes indefinitely or generate harmonic overtones.
Note Bender System: Actuators integrated into the nut to modify string pitch directly, allowing expressive performance techniques.
Control Interface: Multi-function toggle switches and touch sensors for selecting pickup modes, activating sustain, or engaging the note bender.
Output Module: Wired ¼″ or ⅛″ jack and wireless transmitter (2.4 GHZ, Bluetooth, or RF) for routing processed signals to amplifiers, DAWs, or audio processors.
Power Supply: Rechargeable battery integrated into the nut or via a compact module, supporting portable operation and wireless output.

### 3. Functionality

The pickup assembly captures string vibrations and sends raw signals to the AI processing module.
The AI module analyzes tonal characteristics, playing dynamics, and performance style, applying adaptive EQ, harmonization, and sustain adjustments.
The sustain mechanism maintains or enhances string vibration for extended notes and harmonic effects.
The note bender system allows the performer to raise or lower pitch at the nut with precision.
The control interface provides user-selectable modes for switching between pickup types, sustain settings, and pitch modulation functions.
Processed signals are routed to the output module for wired or wireless amplification, effects, or recording.

### 4. Installation & Usage Instructions

1 Placement: Insert the universal nut assembly into the guitar's nut slot. Compatible with standard and Floyd Rose locking nuts.
2 Securement: For Floyd Rose nuts, use existing locking screws; for traditional nuts, ensure snug fit using provided hardware.
3 Connectivity: Connect wired output to an amplifier, audio interface, or DAW. Activate wireless transmitter for cable-free operation.
4 Power: Charge the integrated battery if applicable; supports continuous operation during practice or performance.
5 Controls: Use toggle switches or touch sensors to select pickup type, activate sustain, and engage note bending functions.
6 Signal Processing: AI module automatically adapts tone, sustain, and harmonic response based on playing dynamics.

### 5. Alternative Embodiments & Customization

Pickup Types: Supports piezoelectric, magnetic, optical, or future sensor technologies; modular design allows upgrades.
Materials: Nut may be constructed from bone, TUSQ, synthetic polymers, metal, carbon fiber, composites, or any suitable material.
Sustain Modes: Fundamental, harmonic, or AI-adaptive sustain matching playing style and musical context.
Note Bender Variants: Manual, automated, or AI-controlled pitch modulation systems.
Wireless Configurations: Bluetooth, RF, or 2.4 GHz modules; optional hybrid wired/wireless setups.
Form Factors: Designed for retrofit installation in electric or acoustic guitars without structural modification.

### 6. Advantages of the Invention

Converts the guitar nut into an active, multifunctional component for signal capture, sustain, and modulation.
Enables direct capture of string vibrations at the nut for acoustic-quality signals.
Supports multiple pickup technologies for maximum tonal flexibility.
Integrates AI-driven real-time tone shaping, sustain management, and performance adaptation.
Incorporates a note bender system for precise pitch modulation directly at the nut.
Wired and wireless outputs allow seamless connection to modern audio systems.
Retrofit installation ensures compatibility with existing guitars without permanent modifications.
Expands expressive capabilities and performance versatility beyond traditional pickup and nut designs.

### Conclusion

The Universal Guitar Nut Pickup and Signal Processing System with Integrated AI, Sustainer, and Note Bender Capability transforms the traditionally passive guitar nut into an active, multifunctional component. By capturing string vibrations directly at the nut, whether on a Floyd Rose locking nut or a standard nut, and integrating AI-driven processing, sustain enhancement, and note bending, the system expands tonal and expressive possibilities for guitarists.

This invention provides modular, retrofit compatibility with existing guitars, supporting multiple pickup technologies, wireless and wired outputs, and adaptive real-time signal processing. Guitarists gain unprecedented control over tone, dynamics, sustain, and pitch modulation without requiring structural modifications. By unifying nut-based pickup, processing, and modulation into a single system, this invention establishes a new standard for musical expression, performance versatility, and digital integration in both electric and acoustic guitars.

1. A universal guitar nut assembly comprising:
an integrated pickup system positioned within a guitar nut, wherein the pickup system detects string vibrations at the headstock end of the guitar;
a signal processing module configured to receive the pickup signals and apply real-time adaptive tone shaping, harmonic enhancement, and sustain control;
a sustain enhancement mechanism configured to induce or amplify string resonance;
a note bending mechanism integrated within or adjacent to the nut, enabling pitch modulation of individual strings; and
an output interface capable of wired or wireless signal transmission to an amplifier, audio interface, or digital audio workstation.

2. A method for capturing, processing, and modulating guitar string vibrations, comprising:
mounting a universal pickup system within a guitar nut;
detecting string vibrations through piezoelectric, magnetic, optical, or alternative sensors;
applying real-time AI-driven tone shaping, adaptive sustain control, and harmonic enhancement;
enabling note bending or harmonic modulation at the nut; and
routing the processed signal through wired or wireless output to an audio system or DAW.

3—The nut assembly of claim 1, wherein the pickup system is modular and supports multiple sensor types, including piezoelectric, magnetic, and optical.

4—The nut assembly of claim 1, wherein the sustain mechanism includes fundamental, harmonic, or AI-adaptive modes.

5—The nut assembly of claim 1, wherein the control system incorporates toggle switches, touch sensors, or multi-function buttons for dynamic user control.

6—The nut assembly of claim 1, wherein the output interface includes wired, wireless, or hybrid connections.

7—The method of claim 2, wherein adaptive tone shaping is responsive to user-specific playing behavior and real-time performance dynamics.

8—The nut assembly of claim 1, wherein the nut is constructed from natural or synthetic materials, including bone, TUSQ, carbon fiber, metals, or composites.

9—The method of claim 2, wherein note bending or pitch modulation is automated, AI-controlled, or manually operated.

10—The nut assembly of claim 1, wherein the system is retrofit-installable in existing guitars, including both traditional nuts and Floyd Rose locking nuts, without permanent modification.

11—The nut assembly of claim 1, wherein in one embodiment, the system is implemented on a Floyd Rose locking nut, incorporating principles from prior piezo pickup systems adapted for locking nut configurations.
